(19) United States
(12) Patent Application Publication
(10) Pub. No.: US 2007/0202744 A1
(43) Pub. Date: Aug. 30, 2007

(54) Flat Blade Jack

(76) Inventors: Roland Dümmel, Theilheim (DE); Raimund Huber, Fussen (DE)

Correspondence Address: BLAKELY SOKOLOFF TAYLOR & ZAFMAN, 1279 OAKMEAD PARKWAY, SUNNYVALE, CA, 94085-4040, US

(21) Appl. No.: 10/578,395

(22) PCT Filed: Oct. 14, 2004
(86) PCT No.: PCT/DE04/02318

§ 371 Date: Apr. 2, 2007

(30) Foreign Application Priority Data
Nov. 3, 2003 (DE) 103 51 540.2

(51) Int. Cl. H01R 13/648

(52) U.S. Cl. 439/607

(57) ABSTRACT

The invention relates to a flat blade jack (1) with a socket shaft to accommodate, in an electrically contacting manner, a flat connector. The socket shaft comprises at least one comb-like multitude of essentially parallel contact bridges (3) that extend in the direction of plugging, which comb-like multitude is arranged on at least one broad side of the socket shaft. In this arrangement the contact bridges (3) are curved towards the middle of the socket shaft.

According to the invention the flat blade jack (1) is characterised in that the section of the contact bridges (3), which section is curved towards the middle of the shaft, in the region of the contact zone with the flat connector comprises more than one vertex (6, 7). Thanks to the flat blade jack according to the invention it becomes possible to particularly reliably design electrical plug-type connections, for example with contact blades of flat connectors or of fuses or relays. Apart from providing considerable improvements relating to current-carrying capacity, reliability and evenness of the force gradient during plug-in, the invention at the same time provides economic advantages due to the ability to efficiently produce flat blade jacks.

The invention relates to a flat blade jack to accommodate, in an electrically contacting manner, a flat connector according to the preamble of claim 1.

In many technical applications, in particular also in motor vehicle engineering, electrical plug-type connections that comprise a flat blade jack and a flat connector, or a flat blade jack and a contact blade, have become extremely widespread due to a combination of advantageous characteristics.

Such electrical plug-type connections can mostly be manufactured relatively economically and can often be assembled by simple pressing onto corresponding cable sets. In this arrangement, assembly can also take place manually with relatively simple means and with hand tools, should this for example become necessary in workshop operations. Furthermore, relatively high currents can be transmitted by way of flat blade connector assemblies, a factor that plays an important role in low-voltage on-board electrical systems of motor vehicles. Frequently, generic flat blade jacks are used in order to electrically contact, and manually hold in place, fuses and relays on printed circuit boards.

For applications with particularly demanding requirements concerning transmissible current intensity, mechanical strength, vibration-resistance and robustness in workshop operations flat blade connectors are known whose socket shaft comprises a contact spring cage or lamella cage. A socket shaft designed in this way provides an advantage in that with it on the one hand a relatively firm grip of the contact blade in the flat blade jack is achieved, and on the other hand due to the increase in the number of electrical contact points between the socket and the connector relatively high current intensity is transmissible. With a suitable arrangement and geometry of the contact springs or lamellae of the socket shaft, these known flat blade connector assemblies moreover provide a certain self-cleaning effect of the electrical contacts, which self-cleaning effect comes to bear each time the electrical contact is disconnected or connected.

However, for applications with particularly demanding requirements concerning fail-safe operation, transmissible current intensity, mechanical strength, while at the same time providing good cost effectiveness as required, known flat blade connector assemblies are suitable only to a limited extent. Furthermore, they are often of complicated design, comprise a multitude of individual parts and therefore require a multitude of process steps in their production, which is associated with accordingly high costs.

Against this background it is the object of the present invention to create a flat blade jack for an electrical flat blade connector assembly which overcomes the above-described disadvantages of the state of the art. In particular, the electrical flat blade connector assembly is to combine particularly good mechanical reliability with electrical transmission reliability at a high maximum current-carrying capacity. Moreover, the flat blade connector assembly must be able to be produced economically with optimal material use and with minimal use of means of production.

This object is achieved by a flat blade jack according to the teaching of claim 1.

Preferred embodiments of the invention form part of the subordinate claims.

In a way which at first is known per se, the flat blade jack according to the invention comprises a socket shaft to accommodate and electrically contact a flat connector or a contact blade, wherein the socket shaft comprises at least one comb-like multitude of essentially parallel contact bridges that extend in the direction of plugging, which comb-like multitude is arranged on at least one broad side of the socket shaft. In this arrangement, in a manner which is also known per se, the contact bridges are curved towards the middle of the socket shaft.

According to the invention, the flat blade jack, however, is characterised in that the curvature of the section of the contact bridges, which section is curved towards the middle of the shaft, in the region of the contact zone with the flat connector comprises more than one vertex.

In other words this means that in a way that is different from the state of the art where each of the bridges from the multitude of contact bridges of the socket shaft only has one vertex and thus only one contact point with the flat blade jack or with the contact blade, according to the invention for each bridge several, preferably two, contact points or contact zones are available for transmitting electrical current. This is also advantageous in that in this way greater mechanical clamping forces can be achieved between the flat blade jack and the flat connector or the contact blade, which makes a positive contribution both to the mechanical and the electrical reliability of the plug-type connection.

Thanks to the invention the increased clamping forces are, however, achieved without the plug-in forces that are required for this necessarily increasing to the same extent. For, when plugging the contact blade into the flat blade jack according to the invention, the vertices, of which there are for example two, of the contact bridges do not have to be overcome by the contact blade at the same time; instead they can be overcome in succession one after the other. In this way the force-path gradient during plugging of the contact blade into the socket shaft is smoothed, which considerably facilitates manual production of the plug-type connection.

As far as the invention is concerned it is at first not essential in what way the electrical or mechanical connection of the flat blade jack to the adjacent components takes place, as long as the current flow can be ensured on a permanent basis and as long as the forces acting on the plug-type connection can be absorbed. According to a preferred embodiment of the invention the flat blade jack is, however, characterised by soldering legs or push-in pins for electrically contacting installation of the flat blade jack in particular on a printed circuit board. In this arrangement the soldering legs or push-in pins are arranged as a prolongation of at least one of the two broad sides of the flat blade jack. In this arrangement it is particularly preferred if the soldering legs or push-in pins are designed in one piece with the respective broad side of the flat blade jack.

This leads to the ability to particularly easily produce the flat blade jack and thus to low production costs. Furthermore, this arrangement of the soldering legs or the push-in pins results in a particularly robust connection between the flat blade jack and the printed circuit board, in particular when both broad sides of the flat blade jack comprise soldering legs or push-in pins.

As an alternative to soldering, it is also possible to use crimp bridges for electrically contacting installation of the flat blade jack. This is in particular suitable for establishing contact at the end of a cable.

According to another preferred embodiment of the invention the flat blade jack is a single-piece stamped bent part. In this arrangement the stamped bent part, perpendicular to the direction of plug-in of the plug-type connection between the flat blade jack and the flat connector, is bent to form a rectangular box profile. This embodiment is in particular associated with an advantage in that it is extremely economical and efficient to produce. Furthermore, a single-piece design of the flat blade jack also results in particularly good robustness and stability of the flat blade jack.

According to a further preferred embodiment of the invention a locking mechanism of the rectangular box profile of the flat blade jack is formed by pairing, having positive fit, comprising at least one notch and at least one strap. In this arrangement the notch comprises an undercut, while the strap is designed so as to be complementary in shape with the notch. This results in a locking mechanism of the box profile of the flat blade jack, which locking mechanism is both easy to produce and robust, because the lock elements are formed in a single piece to the rectangular box profile of the flat blade jack, wherein the lock elements moreover can be produced already during stamp bending. In addition, in this way no further expensive production processes, such as for example welding, are necessary to lock the box profile.

According to further particularly preferred embodiments of the invention, pairing, having positive fit, comprising notch and strap is arranged on a narrow side of the socket shaft, or pairing, having positive fit, comprising notch and strap is additionally stamped after joining so as to be non-positive. Both the above result in particularly good rigidity, in particular torsional rigidity and flexural rigidity, of the box profile of the flat blade jack.

According to a further preferred embodiment of the invention the flat blade jack comprises at least one support spring arranged on the front of the socket shaft. The support spring forms a further mechanical and/or electrical contact zone between the flat blade jack and the flat connector. This results in the ability to transmit an even higher nominal current by means of the plug-type connection, and further results in better guidance of the contact blade when the plug-type connection is established, as well as in improved reliability against unintended pulling out of the contact blade from the flat blade jack. In this arrangement it is particularly preferred if the support spring, of which there is at least one, is formed also in a single piece to a narrow side of the socket shaft, which forming can for example take place by notching already during stamp bending of the sheet metal material of the socket shaft.

According to a further preferred embodiment of the invention the socket shaft, in addition to the contact bridges extending between the ends of the socket shaft, comprises axially extending stabilisation bridges. These stabilisation bridges securely interconnect the two axial ends of the socket shaft at an invariable distance.

This is advantageous in that thanks to the stabilisation provided by the stabilisation bridges no change in the length of the socket shaft can take place when the contact blade is inserted. Moreover, the stabilisation bridges prevent any deformations of the socket shaft, which deformations might otherwise occur in particular in the case of incorrect plugging-in or in the case of non-coaxial plugging-in of the contact blade. Moreover, the stabilisation bridges prevent the possibility of bending forces being transmitted to the soldering positions between the flat blade jack and the printed circuit board because the stabilisation bridges ensure a constant shape of the socket shaft and thus constant spacing and a constant angle of the soldering legs. Finally, the stabilisation bridges moreover make it possible to achieve still greater contact forces between the contact bridges and the contact blade, in particular since the stabilisation bridges reliably prevent any axial changes in the length of the socket shaft due to deformation of the contact bridges when the contact blade is plugged in.

In this arrangement the stabilisation bridges are preferably formed by the longitudinal edges of the rectangular box profile. This is advantageous since in this way optimal utilisation of space in the region of the socket shaft takes place. Furthermore, this results in a socket shaft with maximum flexural strength and maximum torsional rigidity.

In principle, the flat blade jack according to the invention can be made from a host of different conductive materials. However, according to a preferred embodiment of the invention the flat blade jack is made from highly conductive material which at the same time provides particularly good specific elasticity. In this way high nominal currents can be transmitted, and furthermore there is an excellent fail-safe in the face of mechanical overloads of the plug-type connection.

Below, the invention is explained in more detail with reference to the drawings that merely show exemplary embodiments.

The following are shown:

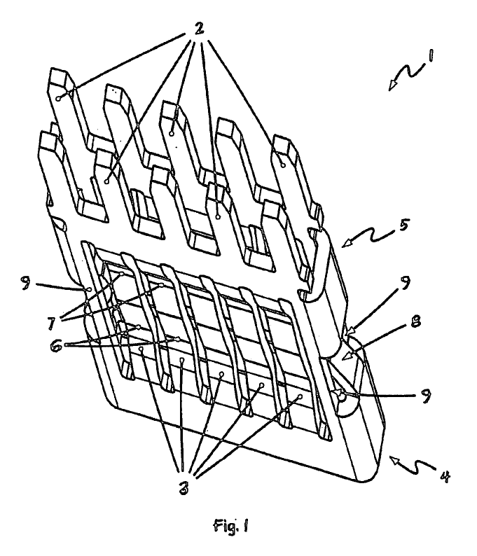

FIG. 1 an isometric view of an embodiment of a flat blade jack according to the present invention;

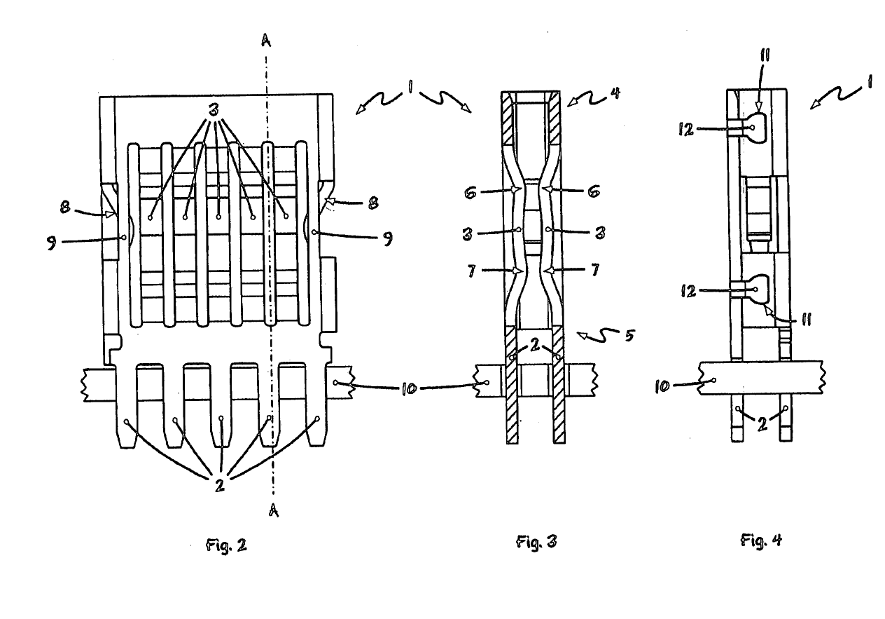

FIG. 2 a diagrammatic lateral view of the flat blade jack according to FIG. 1;

FIG. 3 a longitudinal view that corresponds to that of FIG. 2 of the flat blade jack according to FIGS. 1 and 2;

FIG. 4 a view that corresponds to FIGS. 2 and 3 of the flat blade jack according to FIGS. 1 to 3, wherein the lock side of the socket shaft is shown;

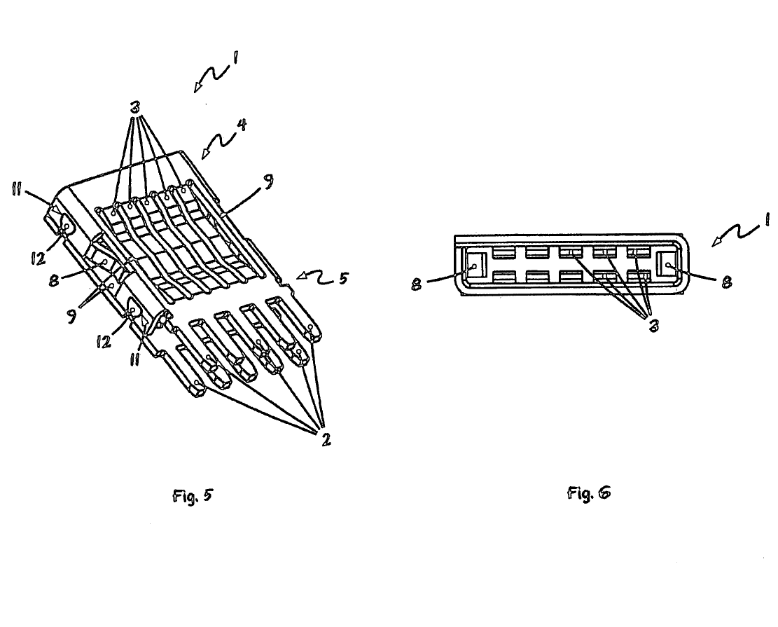

FIG. 5 a view that corresponds to FIG. 1 of the flat blade jack according to FIGS. 1 to 4, wherein the lock side of the socket shaft is shown; and

FIG. 6 in a view that corresponds to that of FIGS. 2 to 4, a top view of the flat blade jack according to FIGS. 1 to 5.

FIG. 1 is an isometric view of an embodiment of a flat blade jack 1 according to the present invention, with the view obliquely from below onto the soldering legs or push-in pins 2. The diagram shows that the flat blade jack 1 is designed as a single-piece sheet metal stamped bent part, wherein the stamped bent part has been bent to form a rectangular box profile.

In each case a multitude of contact bridges 3 that establish both mechanical and electrical contact between the flat blade jack 1 and a flat connector (not shown) extends right through from the head end 4 to the foot end 5 on each broad side of the box-shaped socket shaft of the flat blade jack 1. In this arrangement, in the region of its section curved towards the middle of the socket shaft, each of the contact bridges 3 comprises two vertices 6, 7 and thus two points of contact with the contact blade of a flat connector.

In this way particularly reliable contact, both electrically and mechanically, is achieved between the contact blade and the flat blade jack 1. In this arrangement, when the contact blade is pushed in, first the group 6 of the vertices 6, 7 that are situated closer to the head end 4 of the flat blade jack is contacted, wherein the group 7 of the vertices 6, 7, that face the foot end 5 of the flat blade jack 1 at this point in time can still deflect towards the middle of the socket shaft.

Only when the contact blade is further inserted is contact established with the second group of the vertices 6, 7 that are closer to the foot end 5 or closer to the soldering legs 2 of the flat blade jack 1, and said second group 7 is also displaced from the middle of the socket shaft towards the outside. In this arrangement, due to the mechanical connection between each two vertices 6, 7., by way of the contact bridge 3 at the same time also the contact pressure of the first group 6 of the vertices 6, 7 of the multitude of contact bridges 3 is further increased.

This particular plug-in behaviour of the flat blade jack 1 according to the invention combines smooth and even plug-in action with concurrently achievable maximum electrical and mechanical contact reliability between the flat blade jack 1 and the contact blade of a flat connector.

FIG. 1 also shows one of the lateral support springs 8 that are arranged on the narrow sides of the socket shaft and that are also designed in a single piece with the flat blade jack, which support springs 8 can additionally be used for transmitting current. Furthermore, the support springs 8 ensure better guidance of the contact blade in the socket 1, thus improving the reliability against unintended unplugging of the contact blade from the flat blade jack 1.

Furthermore, FIG. 1 also shows the way in which the socket shaft is reinforced by the axially extending stabilisation bridges 9. The stabilisation bridges 9, which in the embodiment shown are formed by the four longitudinal edges 9 of the rectangular box profile of the socket shaft, ensure that the length and the shape of the socket shaft remain the same, in particular when plugging in a flat connector but also during operation of the plug-type connection. In this way the stabilisation bridges 9 make a very significant contribution to the robustness and to the increase in fail-safe operation, both mechanically and electrically, of the plug-type connection.

FIG. 2 shows a diagrammatic lateral view of the flat blade jack 1 according to FIG. 1. In this arrangement the flat blade jack 1 is arranged, by means of its push-in pins or soldering legs, in the matrix of holes of a printed circuit board 10. FIG. 2 clearly shows the structure of the flat blade jack 1, which in a single piece comprises contact bridges 3, support springs 8, stabilisation bridges 9 and push-in pins or soldering legs 2.

FIG. 3, which is a longitudinal section view of the flat blade jack according to FIGS. 1 and 2 along the line A-A of FIG. 2, particularly clearly shows the design of the contact bridges 3, each of which according to the invention comprises two vertices 6, 7 or two contact points 6, 7 to contact the contact blade (also not shown in the diagram) of the flat connector.

When the contact blade is pushed in, first the vertices 6 of the contact bridges 3, which vertices 6 are situated more closely to the head region 4 of the flat blade jack 1, are displaced towards the outside. At this stage the maximum spring tension of the contact bridges 3 is not yet achieved because the further vertices 7 of the contact bridges 3, which vertices are situated more closely to the foot region 5 of the flat blade jack 1, at first can still deflect towards the middle of the socket shaft. Only when the contact blade is pushed in further, is the second group 7 of the vertices 6, 7 also displaced from the middle of the socket shaft towards the outside, which makes it possible for the maximum spring forces in the contact bridges 3 to occur. These spring forces then also act back in an additionally force-increasing manner, on the contact force between the first group 6 of the vertices 6, 7 and the contact blade.

Because the stabilisation bridges 9 (FIG. 2) that are formed by the four longitudinal edges 9 of the socket cage prevent any extension of the spacing between the head region 4 and the foot region 5 of the flat blade jack 1, plugging in a contact blade subjects the contact bridges 3 not only to flexural tension but also to axial compressive strain, which further improves the electrical contact and the mechanical clamping behaviour between the contact blade and the contact bridges 3.

FIG. 4 shows that narrow side of the flat blade jack according to FIGS. 1 to 4, on which narrow side the connection elements 11, 12 for the locking mechanism of the rectangular box profile are located.

In particular the design shape of the lock elements 11, 12 of the rectangular box profile of the flat blade jack 1 is clearly shown. To this effect the stamped bent part from which the flat blade jack 1 is formed comprises two undercut notches 11 on one of its two narrow sides, which notches 11 are arranged in rectangular prolongations of the stamped bent part. Two straps 12, which are formed in a single piece to the other narrow side of the stamped bent part, which straps 12 are designed so as to be complementary in shape to the notches, wherein the straps are formed on the left side, in the drawing, of the rectangular box profile, engage in the undercut notches 11. This results in a connection having positive fit between the two narrow sides of the stamped bent part, and a flexurally rigid and torsionally rigid rectangular box is formed.

The robustness of this connection can further be increased in that the margins of the strap 12 and the notch 11, which margins are in contact with each other, are pressed together by means of a suitable tool. The resulting engagement of the edges of the strap 12 and the notch 11 brings about an extremely good and play-free connection of the two narrow sides of the stamped bent part or of the abutting edges of the rectangular box profile.

FIG. 5 again is an isometric view of the flat blade jack according to FIGS. 1 to 4, also with a view towards that narrow side of the flat blade jack, on which narrow side the connection elements or lock elements 11, 12 of the rectangular box profile are located. Furthermore, FIG. 5 clearly shows the progression of the contact springs 3, as well as showing the stabilisation bridges 9 and a support spring 8.

FIG. 6 shows a top view of the head region 4 of the flat blade jack according to FIGS. 1 to 5. In particular the all-round containment of the contact blade of a flat connector is clearly shown, which containment results from the vertices 6, 7 or contact points 6, 7 of the contact bridges 3 together with the lateral support springs 8. In this way both a secure electrical contact and a robust mechanical anchorage of the contact blade in the socket cage of the flat blade jack 1 is achieved.

Consequently it becomes clear that thanks to the flat blade jack according to the invention it becomes possible to particularly reliably design electrical plug-type connections, for example with contact blades of flat connectors or of fuses or relays.

Apart from providing considerable improvements relating to the transmissible current intensity, electrical and mechanical reliability, as well as evenness of the force gradient during plug-in, the invention at the same time provides significant economic advantages due to the ability to efficiently produce flat blade jacks according to the invention.

The invention thus combines improvements in the characteristics of flat blade connector assemblies at the same time as a significant cost savings potential in their production and installation.

1. A flat blade jack (1) with a socket shaft to accommodate, in an electrically contacting manner, a flat connector, with the socket shaft comprising at least one comb-like multitude of essentially parallel contact bridges (3) that extend in the direction of plugging, which comb-like multitude is arranged on at least one broad side of the socket shaft, wherein the contact bridges (3) are curved towards the middle of the socket shaft,
characterised in that
the section of the contact bridges (3), which section is curved towards the middle of the shaft, in the region of the contact zone with the flat connector comprises more than one vertex (6, 7).

2. The flat blade jack according to claim 1,
characterised by
soldering legs (2) or push-in pins (2) for electrically contacting installation of the flat blade jack (1) in particular on a printed circuit board (10), wherein the soldering legs (2) or push-in pins (2) are arranged as a prolongation of at least one of the two broad sides of the flat blade jack (1).

3. The flat blade jack according to claim 2,
characterised in that
the soldering legs (2) or push-in pins (2) are designed in one piece with the respective broad side of the flat blade jack (1).

4. The flat blade jack according to claim 1,
characterised in that
the flat blade jack (1) is a single-piece stamped bent part that has been bent perpendicular to the direction of plug-in so as to form a rectangular box profile.

5. The flat blade jack according to claim 4,
characterised in that
a locking mechanism of the rectangular box profile is formed by pairing, having positive fit, comprising at least one notch (11) with an undercut and at least one strap (12) designed so as to be complementary in shape to the notch.

6. The flat blade jack according to claim 5,
characterised in that
pairing, having positive fit, comprising notch (11) and strap (12) is arranged on a narrow side of the socket shaft.

7. The flat blade jack according to claim 5,
characterised in that
pairing, having positive fit, comprising notch (11) and strap (12) is stamped so as to be non-positive.

8. The flat blade jack according to claim 1,
characterised by
at least one support spring (8) arranged on the narrow side of the socket shaft, by which support spring (8) a further mechanical and/or electrical contact zone with the flat connector is formed.

9. The flat blade jack according to claim 8,
characterised in that
the support spring (8), of which there is at least one, is formed in a single piece to the flat blade jack (1).

10. The flat blade jack according to claim 1,
characterised in that
the socket shaft comprises axially extending stabilisation bridges (9).

11. The flat blade jack according to claim 10,
characterised in that
the stabilisation bridges (9) are formed by the longitudinal edges of the rectangular box profile.

12. The flat blade jack according to claim 1,
characterised in that
the flat blade jack (1) is made from highly conductive material of good specific elasticity.

13. The flat blade jack according to claim 1,
characterised by
crimp bridges for electrically contacting installation of the flat blade jack, in particular to the end of a cable, wherein the crimp bridges are arranged as a prolongation of at least one of the two broad sides of the flat blade jack.
